(19) United States
(12) Patent Application Publication
(10) Pub. No.: US 2018/0011850 A1
(43) Pub. Date: Jan. 11, 2018

(54) TEMPORAL-BASED VISUALIZED IDENTIFICATION OF COHORTS OF DATA POINTS PRODUCED FROM WEIGHTED DISTANCES AND DENSITY-BASED GROUPING

(71) Applicant: Hewlett-Packard Development Company, L.P., Houston, TX (US)

(72) Inventors: Ming C. Hao, Palo Alto, CA (US); Dominik Jackle, Palo Alto, CO (US); Wei-Nchih Lee, Palo Alto, CA (US); Nelson L. Chang, San Jose, CA (US); Daniel Keim, Konstanz (DE); Justin Aaron Scaggs, Plano, TX (US)

(21) Appl. No.: 15/544,693

(22) PCT Filed: Mar. 17, 2015
(86) PCT No.: PCT/US2015/021015

§ 371 Date: Jul. 19, 2017

(51) Int. Cl. G06F 17/30; G06K 9/62; G06K 9/68

(52) U.S. Cl. CPC G06F 17/3028; G06K 9/6878; G06F 17/3025; G06K 9/6218

(57) ABSTRACT

A user-selected group of data points is received. Weighted distances between further data points with the user-selected group of data points are computed, the weighted distances computed based on respective weights assigned to dimensions of data points. Density-based grouping of the further data points is performed based on the computed weighted distances, the density-based grouping producing cohorts of data points. A graphical visualization is generated including pixels representing the user-selected group of data points and the cohorts of data points. The graphical visualization provides a temporal-based visualized identification of the cohorts with the user selected group of data points.

### BACKGROUND

A large amount of data can be produced or received in an environment, such as a network environment that includes many machines (e.g. computers, storage devices, communication nodes, etc.), or other types of environments. As examples, data can be acquired by sensors or collected by applications. Other types of data can include financial data, health-related data, sales data, human resources data, and so forth.

### BRIEF DESCRIPTION OF THE DRAWINGS

Some implementations of the present disclosure are described with respect to the following figures.

FIG. 1 is a schematic diagram of an example temporal plot according to examples of the present disclosure.

FIG. 2 is a schematic diagram illustrating an example of determining a distance between a data point and a user-selected group of data points, according to some implementations.

FIG. 3 is a graph illustrating examples of cohorts of data points, determined using techniques according to some implementations.

FIG. 4 is a flow diagram of an example process according to some implementations.

FIG. 5 is a schematic diagram of an example graph depicting destination port values of data points as a function of time, according to some examples.

FIG. 6 is a visualization of an example temporal plot depicting multidimensional scaling (MDS) values of data points as a function of time, according to some implementations.

FIG. 7 is a schematic diagram of another example graph depicting destination port values of data points as a function of time, according to some implementations.

FIG. 8 is a schematic diagram of a cohort selection screen to select a cohort, according to some implementations.

FIG. 9 is a visualization of another example temporal plot depicting MDS values of data points as a function of time, according to some implementations.

FIG. 10 is a schematic diagram of a further example graph depicting destination port numbers of data points as a function of time, according to some implementations.

FIG. 11 is a block diagram of an example computer system according to some implementations.

### DETAILED DESCRIPTION

Activity occurring within an environment can give rise to events. An environment can include a collection of machines and/or program code, where the machines can include computers, storage devices, communication nodes, and so forth. Events that can occur within a network environment can include receipt of data packets that contain corresponding addresses and/or ports, monitored measurements of specific operations (such as metrics relating to usage of processing resources, storage resources, communication resources, and so forth), or other events. Although reference is made to activity of a network environment in some examples, it is noted that techniques or mechanisms according to the present disclosure can be applied to other types of events in other environments, where such events can relate to financial events, health-related events, human resources events, sales events, and so forth.

Generally, an event can be generated in response to occurrence of a respective activity. An event can be represented as a data point (also referred to as a data record).

Each data point can include multiple dimensions (also referred to as an attribute), where an attribute can refer to a feature or characteristic of an event represented by the data point. More specifically, each data point can include a respective collection of values for the multiple attributes. In the context of a network environment, examples of attributes of an event include a network address attribute (e.g. a source network address and/or a destination network address), a network subnet attribute (e.g. an identifier of a subnet), a port attribute (e.g. source port number and/or destination port number), and so forth. Data points that include a relatively large number of attributes (dimensions) can be considered to be part of a high-dimensional data set.

Finding patterns (such as patterns relating to failure or fault, unauthorized access, or other issues) in data points representing respective events can be difficult when there is a very large number of data points. For example, some patterns can indicate an attack on a network environment by hackers, or can indicate other security issues. Other patterns can indicate other issues that may have to be addressed.

For example, to identify security attack patterns in a high-dimensional data set collected for a network environment, analysts can use scatter plots for identifying patterns associated with security attacks. A scatter plot includes graphical elements representing data points, where positions of the data points in the scatter plot depend on values of a first attribute corresponding to an x axis of the scatter plot, and values of a second attribute corresponding to a y axis. In some examples, the first attribute can be time, while the second attribute can include a value of a port (e.g. destination port) that is being accessed.

If ports are scanned (accessed) sequentially by security attacks, the security attacks can be manifested as a visible diagonal pattern in the scatter plot. If the ports are accessed in randomized order, however, the port scans may not be visible in the scatter plot.

In accordance with some implementations according to the present disclosure, techniques or mechanisms are provided to allow users to identify patterns associated with issues of interest to the users, such as occurrence of security attacks in a network environment, or other issues in other environments. More specifically, techniques or mechanisms are provided to allow users to identify similar patterns within a visualization of data points. Identifying similar patterns can be performed by a user selecting a group of data points that may be indicative of an issue of interest to the user. Based on the selected group of data points, cohorts of data points can be identified, and the similarities of the cohorts of data points to the user-selected group of data points can be indicated. A cohort of data points can refer to a collection of data points that has been identified as having a respective similarity to the user-selected group of data points.

The identification of similar patterns can be based on the combination of weighted distance computations (to compute weighted distances between data points) and density-based grouping of data points. A weighted distance can be used to compare each data point to a user-selected group of data points at a dimensional level. A weighted distance can refer to a measure of how close events are to each other, where the measure is calculated using weights assigned to respective dimensions of the events. Density-based grouping (to determine a density distribution) can be used to place events (data points) in different cohorts based on specified threshold (which can be user-specified). Density-based grouping can refer to a process of identifying multiple cohorts of data points, in which data points that are close to each other (that have small weighted distances) are collected together into cohorts; each cohort is a dense group of data points.

Further details regarding the computations of weighted distances and density-based grouping are discussed further below.

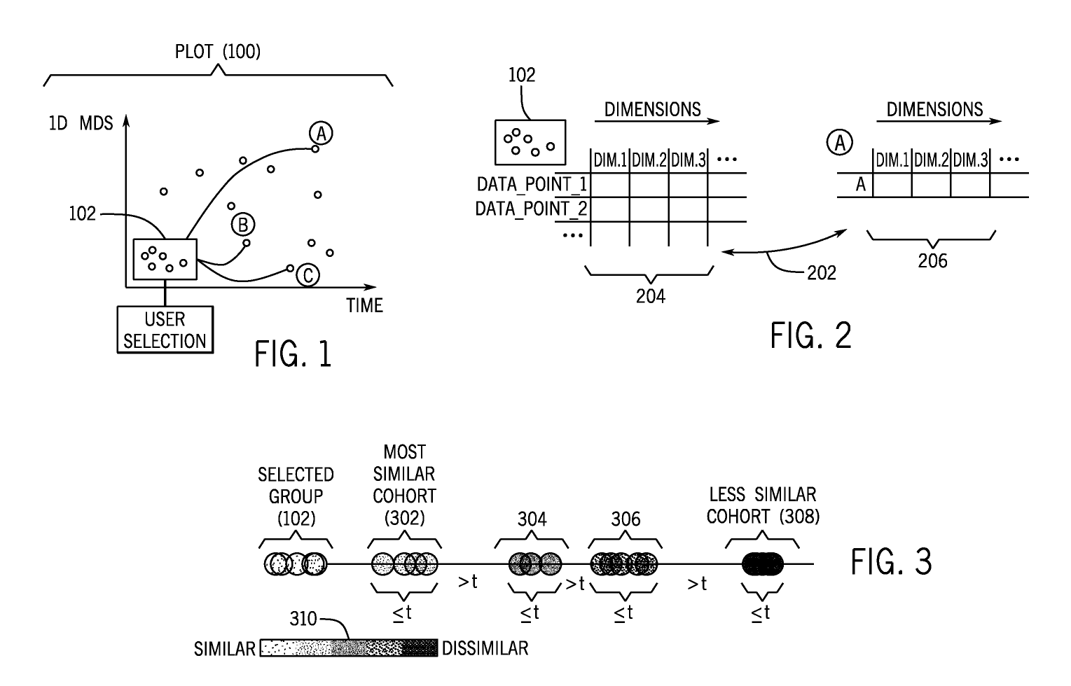

FIG. 1 illustrates an example temporal plot 100 of data points, where the data points are represented by respective graphical elements (e.g. in the form of circles or dots) in the plot 100. The horizontal axis of the plot 100 is a time axis that represents different times, and the vertical axis of the plot 100 represents one-dimensional (1D) multidimensional-scaling (MDS) values for the respective data points depicted in the plot 100. MDS is used for visualizing a level of similarity of individual data points of a dataset. An MDS technique can place data points (in one or multiple dimensions) such that distances between the data points are preserved. In the plot 100, since the distance between data points is along one direction (the vertical direction), the MDS values depicted in the plot 100 are considered 1D MDS values. The computation of MDS values can employ various techniques, including those described in Bryan F. J. Manly, “Multivariate Statistical Methods: A Primer, Third Edition,” CRC Press, 2004, pp. 163-172.

As shown in the example of FIG. 1, a user selection of a group 102 of data points can be made in the plot 100, which can be presented in a display device of a system, in some examples. User selection of the group 102 of data points can be made using an input device (such as a mouse, touchpad, keyboard, touchscreen, etc.). The plot 100 also includes data points A, B, and C (along with other data points). The data points A, B, C and other data points outside the group 102 of data points are referred to in the ensuing discussion as “further data points.”

FIG. 2 shows a first matrix 204 that includes multiple rows corresponding to the data points of the group 102. The data points in the selected group of 102 data points include DATA_POINT_1, DATA_POINT_2, and so forth. Each data point has multiple dimensions (dimension 1, dimension 2, and dimension 3 depicted in FIG. 2).

FIG. 2 also shows a matrix 206 for data point A, which also has multiple dimensions.

A distance (or more specifically, a weighted distance) between data point A and the user-selected group 102 of data points is determined (as represented by 202). The process of determining distances between a respective data point and the user-selected group 102 of data points can be repeated for multiple further data points, such as those included in the plot 100.

Weighted distances are computed based on respective weights assigned to dimensions of a further data point and dimensions of the data points in the user-selected group 102. In other words, a specific weight is assigned to each dimension of the data points, where the weights assigned to different dimensions can be different. The weights are assigned based on user selection, for example. In the example of FIG. 2, a first weight w(1) can be assigned to dimension 1, a second weight w(2) can be assigned to dimension 2, and a third weight w(3) can be assigned to dimension 3. If the data points have further dimensions, then more weights can be assigned to the further dimensions.

The weighted distance between data points is based on performing binary comparisons between the data points, where the binary comparisons are based on respective weights assigned to the dimensions. Since the computation of the weighted distance between data points has to be able to handle categorical data (as well as numerical data), techniques or mechanisms according to some implementations of the present disclosure perform the binary comparisons rather than computations of Euclidean distances between data points. Categorical data is data that do not have numerical values, but rather, have values in different categories. An example of categorical data can include location data, where location can be identified by different city names (the categories). Thus, the categorical values of the location dimension (which is a categorical dimension) can include Los Angeles, San Francisco, Palo Alto, and so forth.

The binary comparison of two data points is illustrated by Table 1 below.

TABLE 1

| | Dimension 1 | Dimension 2 | Dimension 3 |
|---|---|---|---|
| Data Point A | W | X | Z |
| Data Point B | W | Y | Z |
| Distance: | 0 | 1 | 0 |

In the example above, it is assumed that each of data points A and B has three dimensions (dimension 1, dimension 2, dimension 3). For data point A, the values of dimensions 1, 2, and 3 are W, X, and Z, respectively. For data point B, the values of dimensions 1, 2, and 3 are W, Y, and Z, respectively.

A string comparison per dimension is performed between data points A and B. For dimension 1, both data points A and B share the same value; as a result, the similarity is high, and thus, the string comparison for dimension 1 outputs a binary value of 0. The same is also true for dimension 3, where data points A and B both share the same value D. As a result, the distance between data points A and B along dimension 3 is also assigned the binary value 0. However, for dimension 2, data points A and B do not have the same value, and thus, the distance between data points A and B along dimension 2 is assigned the binary value 1. The foregoing comparisons of the data points along respective dimensions are referred collectively as binary comparisons, since the outputs produced by the comparisons include a collection of binary values indicated similarity or dissimilarity along respective different dimensions. In other examples, high similarity can be represented with the binary value 1, while low similarity (or dissimilarity) can be represented with the binary value 0.

More specifically, to compute the similarity value between two data points A and B, the computation iterates through all dimensions starting at i=1 (first dimension) and ending at the number of dimensions dim. The computation can then use Iverson Brackets [ ] to compare the i-th dimension of the data points A and B to each other. Then the result, either 0 or 1, is multiplied with the weight w(i) at position i: w(i). To build the average (i.e. the weighted distance between data points A and B), the computation sums the foregoing weighted values and divide by the number of dimensions (dim) as specified in the following equation:

$$sim ( A , B ) = \frac{{\sum }_{i = 1}^{dim} [ A ( i ) \neq B ( i ) ] \cdot w ( i )}{dim} . \qquad ( Eq . 1 )$$

The weighted distance between data points A and B is represented as sim(A, B) above.

Note that when determining the weighted distance between a further data point (e.g. a data point A, B, or C in FIG. 1) with the data points in the user-selected group (e.g. 102), the further data point is compared to each data point of the user-selected group individually, to produce multiple sim(A, Cⱼ) values, where j=1 to M (M>1 and representing the number of data points in the user-selected group), corresponding to similarities between the further data point and respective data points 1 to M in the user-selected group.

The multiple sim(A, Cⱼ) values are averaged to produce an aggregate weighted distance between the further data point and the data points in the user-selected group. In other examples, instead of averaging the multiple sim(A, Cⱼ) values, a different aggregation can be performed, such as a sum or other aggregate.

The aggregate weighted distance represents the similarity between the further data point and the user-selected group of data points. The aggregate weighted distance WD can be used as a similarity value for indicating similarity between a further data point and the user-selected group of data points. In other examples, a similarity value can be derived from the aggregate weighted distance.

Based on the determined aggregate weighted distances of further data points to the user-selected group 102 of data points, multiple cohorts 302, 304, 306, and 308 of data points can be identified, as shown in FIG. 3. The multiple cohorts 302, 304, 306, and 308 have different similarities to the user-selected group 102 of data points, as represented by different relative distances between the cohorts and the user-selected group 102 in FIG. 3. In FIG. 3, the cohort 302 of data points is considered to be the most similar cohort to the selected group 102 of data points (and thus placed closest to the user-selected group 102). On the other hand, the cohort 308 of data points is considered to be less similar to the user-selected group 102 of data points than the other cohorts 302, 304, and 306 of data points, and thus placed farthest from the user-selected group 102).

A threshold t (which can be user-specified or specified by another entity) can be provided for identifying the cohorts. The threshold t defines the maximum distance between further data points within a particular cohort. In other words, the aggregate weighted distance between any two data points within the particular cohort does not exceed t. Data points that have aggregate weighted distances greater than t are placed in separate cohorts, as shown in FIG. 3. More generally, the aggregate weighted distances of the further data points are compared to the specified threshold t to identify the cohorts.

FIG. 3 also shows that graphical elements (e.g. dots or circles) representing the data points in the different cohorts are assigned different visual indicators (in the form of different fill patterns or colors, for example). The different visual indicators are represented in a scale 310, with cohorts that are more similar to the user-selected group 102 having a fill pattern (or color) to the left of the scale 310, and cohorts that are less similar to the user-selected group 102 having a fill pattern (or color) to the right of the scale 310. The dots representing the data points within a particular cohort are all assigned the same visual indicator (same fill pattern or same color). This allows a user to more easily detect which cohort a data point is part of, and whether the data point is similar or dissimilar to the user-selected group 102.

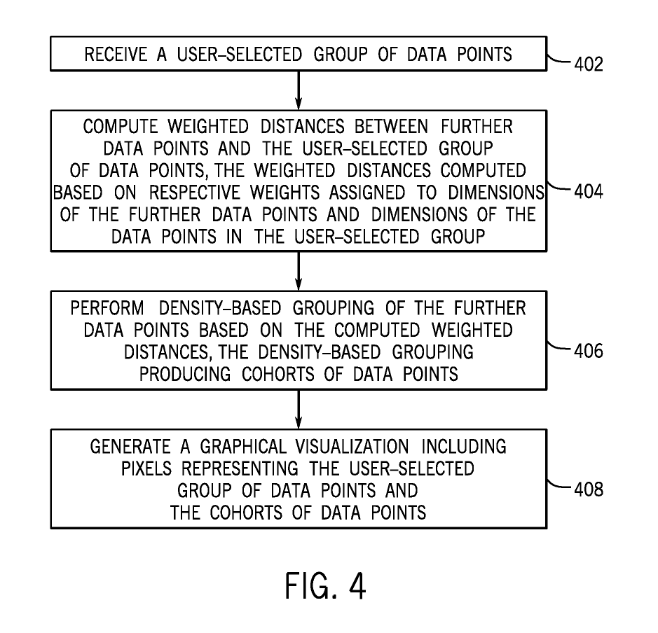

FIG. 4 is a flow diagram of an example process according to some implementations, which can be performed by a computer, an arrangement of computers, a processor, or an arrangement of processors. The process of FIG. 4 receives (at 402) a user-selected group of data points, such as the group 102 shown in FIG. 1. More specifically, the computer(s)/processor(s) that execute(s) the process receives the user-selected group of data points in response to user selection made in a displayed plot.

The process computes (at 404) weighted distances (more specifically, the aggregate weighted distances discussed above) between further data points (e.g. data points A, B, C, etc. in FIG. 1) and the user-selected group of data points. Each weighted distance constitutes a similarity value between a further data point and the user-selected group of data points.

The further data points can be sorted according to their respective similarity values, to produce a sorted list of further data points.

Next, the process of FIG. 4 performs (at 406) density-based grouping of the further data points, in the sorted list, based on the similarity values (e.g. weighted distances), where the density-based grouping produces cohorts of data points (such as the cohorts 302, 304, 306, and 308 of FIG. 3).

In some examples, the density-based grouping performed at 406 can involve iterating through the further data points of the sorted list. For any two further data points whose similarity value is less than the threshold t, the two further data points can be grouped into a corresponding cohort. However, if the similarity value between any two data points exceeds the threshold t, then a cut is defined, and the two data points are provided in different cohorts.

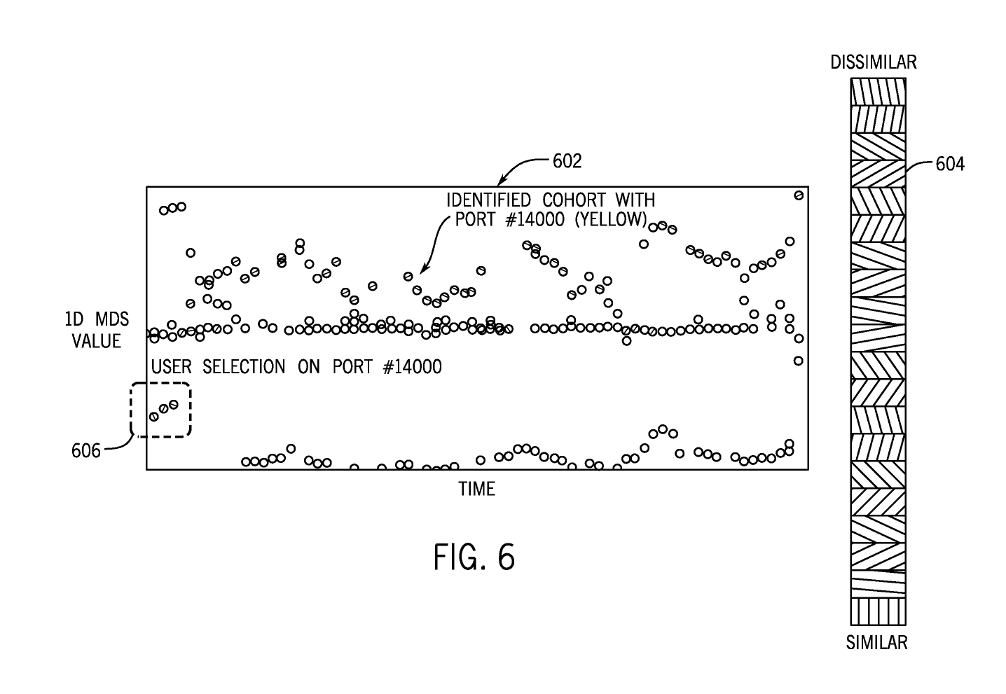

A graphical visualization including graphical elements (e.g. circles or dots) representing the user-selected group of data points and the cohorts of data points is generated (at 408). In the ensuing discussion, graphical elements are referred to as “pixels,” where each pixel represents a respective data point. In the graphical visualization, each cohort is represented using pixels assigned a common visual indicator (e.g. fill pattern or color). The different cohorts can be detected by a user based on the assigned common visual indicators; in other words, a first cohort can be detected based on a first common visual indicator assigned to a group of pixels, a second cohort can be detected based on a second common visual indicator assigned to a group of pixels, and so forth. In some implementations, the graphical visualization represents a temporal plot (such as that depicted in FIG. 6), where an axis of the temporal plot represents time. As a result, the graphical visualization providing a temporal-based visualized identification of the user-selected group of data points and the cohorts in a high-dimensional space (a collection of data points that have a relatively large number of dimensions). The visualized identification of the cohorts can refer to an identification or detection, such as by a user or another entity, of the cohorts based on the graphical visualization. The temporal-based visualized identification of cohorts can refer to an identification or detection of time information associated with the cohorts.

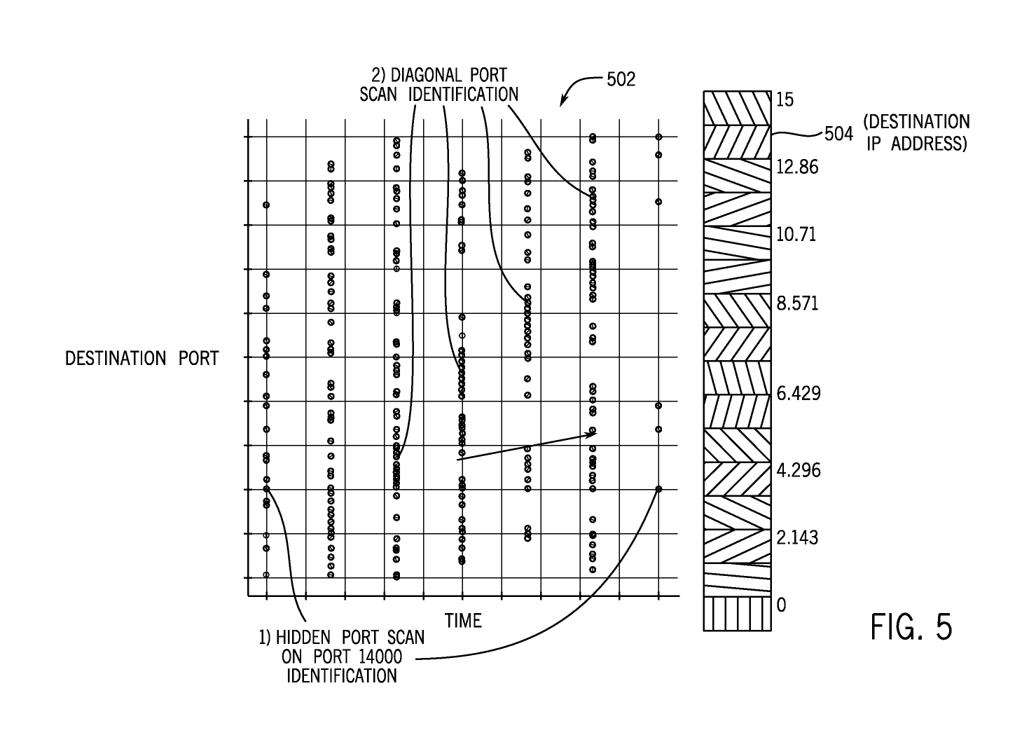

FIG. 5 depicts a graph 502 that shows destination port values (along the vertical axis) of data points as a function of time (along the horizontal axis). The graph 502 is an example of a scatter plot. The position of a pixel representing each data point in the graph 502 is based on the respective value of the destination port (one dimension) and the respective value of time (another dimension). In addition, each data point (represented by a pixel in FIG. 5) can be assigned a specific visual indicator (e.g. fill pattern or color) that represents a further dimension, which in the example of FIG. 5 is a destination Internet Protocol (IP) address. The different visual indicators are shown on a scale 504, where different visual indicators can correspond to different values of the destination IP address dimension. Thus, each pixel representing a respective data point in the graph 502 of FIG. 5 can be assigned a respective visual indicator based on the destination IP address of the data record represented by the pixel.

In the example of FIG. 5, two issues are identified. A first issue relates to a hidden port scan on port 14000, while a second issue relates to a diagonal port scan (indicated by a diagonal pattern). The port scans are examples of possible unauthorized access of ports within a network environment. Although the diagonal port scan issue can be detected by a user in the graph 520, the hidden port scan cannot be easily detected by the user in the graph 502.

FIG. 6 shows a graphical visualization that depicts a temporal plot 602 of data points, where pixels representing the data points are positioned in the temporal plot based on 1D MDS values (vertical axis) and time values (horizontal axis) of the respective data points. The 1D MDS values of the data points can be computed using an MDS technique. The temporal plot 602 is similar to the temporal plot 100 shown in FIG. 1.

In FIG. 6, a user-selected group 606 of data points is depicted. Also, FIG. 6 shows a scale 604 of different visual indicators for indicating whether a data point is similar or not similar to the user-selected group 606 of data points. The similarity is based on computation of the weighted distances between further data points and the user-selected group 606 of data points, and the grouping of the further data points into cohorts, as discussed above.

Once the cohorts are identified, a common visual indicator (same fill pattern or same color) is assigned to the pixel representing each data point of a given cohort. These common visual indicators are assigned to the pixels shown in FIG. 6.

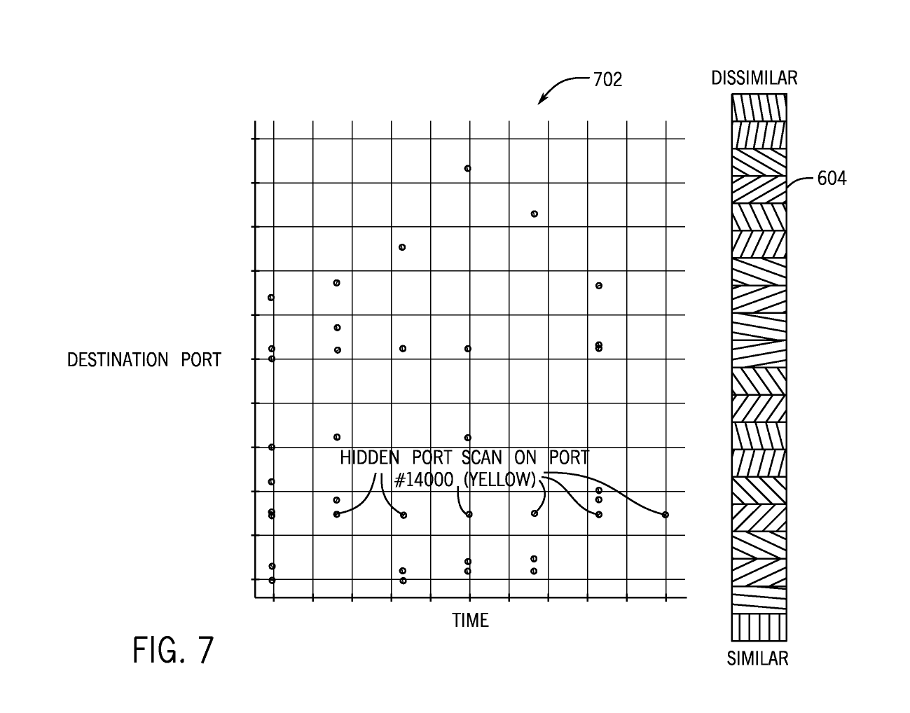

The identified cohorts and their respective assigned visual indicators can be mapped back to a graph that depicts a scatter plot of data points along a destination port dimension and a time dimension, as shown in FIG. 7. In the graph 702 of FIG. 7, pixels representing data points of the identified cohorts are shown. The pixels in the graph 702 are assigned visual indicators corresponding to the cohorts to which the corresponding data points belong. In this way, a user can more easily identify data points associated with issues of interest to the user, such as the hidden port scan issue.

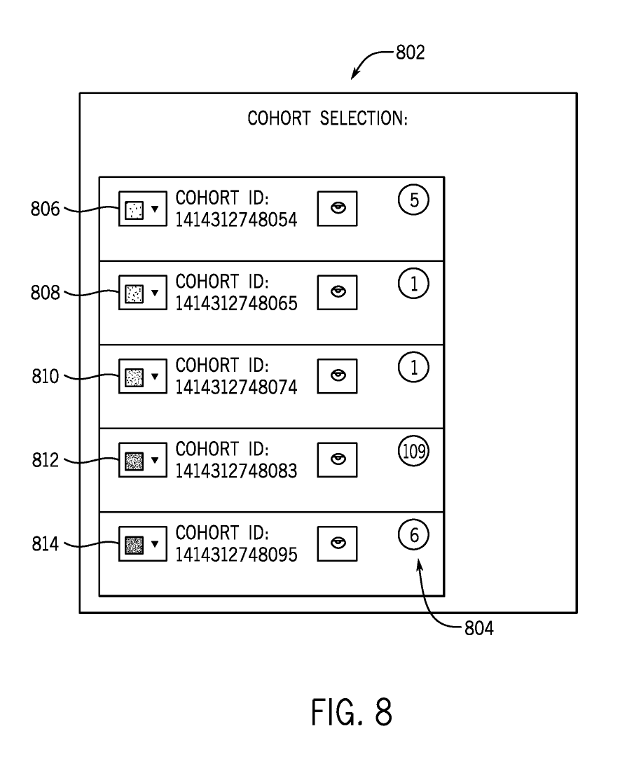

FIG. 8 shows a cohort selection screen 802 that can be presented to a user. More generally, the cohort selection screen 802 is a control screen in which a user can make selections with respect to various tasks that can be performed with respect to identified cohorts. A user can select user-selectable control elements 806, 808, 810, 812, and 814, which correspond to respective different cohorts as identified using techniques or mechanisms according to the present disclosure. The control elements 806, 808, 810, 812, and 814 include respective different visual indicators (e.g. different fill patterns or colors) to indicate whether the respective cohort is similar or dissimilar to the user-selected group. Moreover, a number of data points within each cohort is identified in column 804, where the respective number indicates the number of data points in the corresponding cohort. For example, the first cohort has five data points (indicated by the number 5 in column 804).

User selection of one of the control elements 806, 808, 810, 812, and 814 causes a graphical visualization to be generated that depicts just the data points in the respective cohort associated with the selected control element.

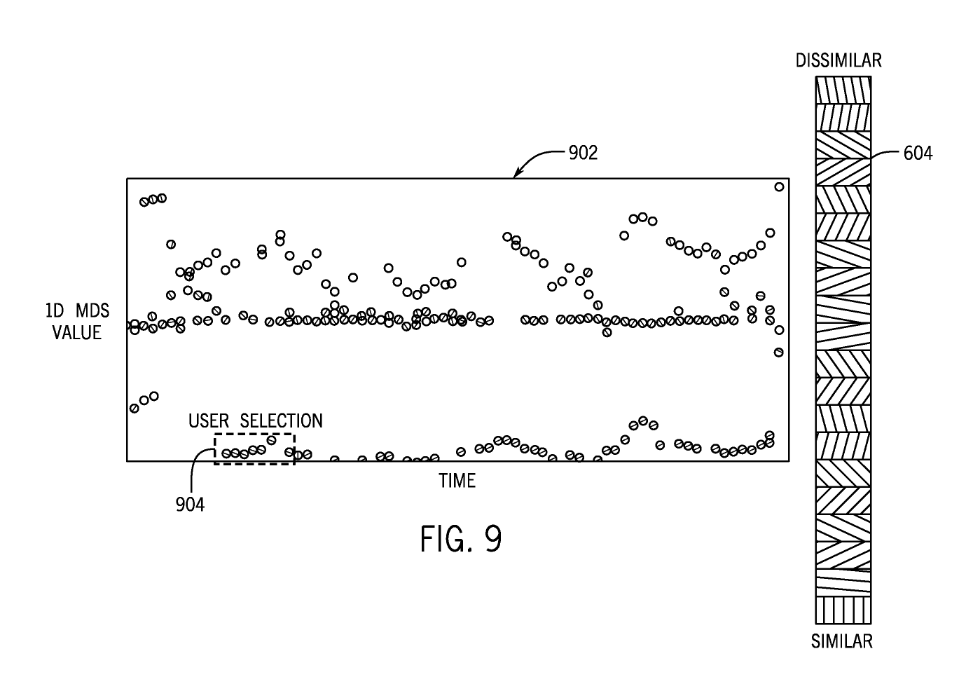

Based on the results depicted in the temporal plot 602 of FIG. 6, a user can decide to select another user-selected group of data points to iterate through another round of weighted distance computations and density-based grouping. For example, FIG. 9 shows another temporal plot 902 that includes the same arrangement of pixels as in FIG. 6, except that a different user-selected group 904 of data points is made in the temporal plot 902. Computations of weighted distances and density-based grouping can then be performed for the user-selected group 904 of data points, with the results visualized in the temporal plot, in the form of different visual indicators assigned to pixels representing data points in different cohorts having different similarities to the user-selected group 904 of data points.

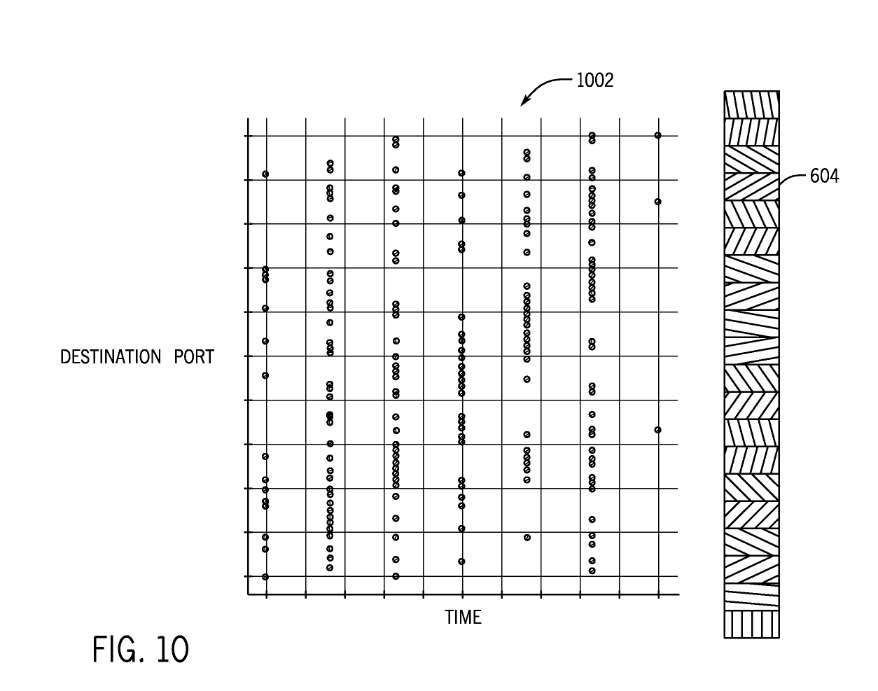

The identified cohorts and respective assigned visual indicators can be mapped to a graph 1002, as shown in FIG. 10, where data points are plotted based on destination port and time values. In FIG. 10, the pixels representing data points in respective cohorts are assigned respective visual indicators.

Flexibility can be provided to a user in the form of the ability to iterate through different results by changing the weights assigned to dimensions of data points, and the selection of different cohorts of data points to which other data points are compared to.

Visual analytic techniques are provided to allow users to find, show, and save patterns in data points. Finding can be accomplished by selecting a user-selected group of data points and initiating the computation of weighted distances an performance of density-based grouping. Once a pattern is detected, the results can be shown in the various visualizations discussed above, and also saved.

In some implementations, a user can merge, delete, or display patterns. For example, control elements (such as those shown in FIG. 8) to allow the user to select a cohort (and thus a pattern) to display. Control elements can also be provided to allow users to merge patterns (by merging cohorts) or to delete patterns (by deleting cohorts). For example, in FIG. 8, the control elements available to a user can include a merge button (to merge two or more cohorts) or a delete button (to delete a respective cohort). Merging cohorts can cause data points in the merged cohort to be assigned a common visual indicator. Deleting a cohort can cause the cohort to no longer be visualized.

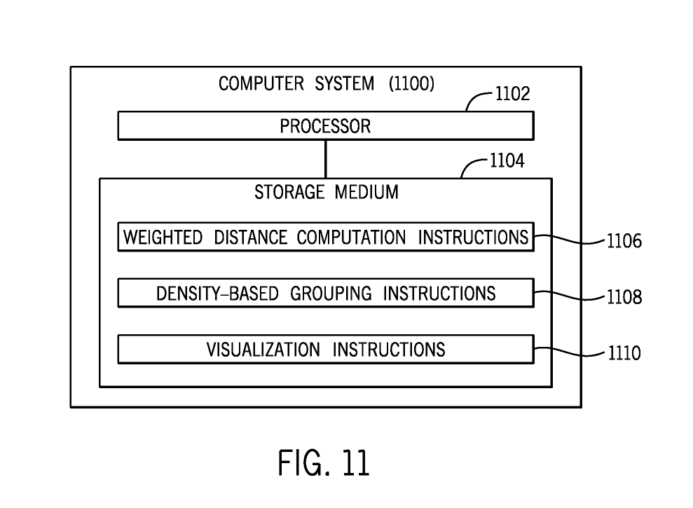

FIG. 11 is a block diagram of an example computer system 1100 according to some implementations. The computer system 1100 includes a physical or hardware processor (or multiple processors) 1102. A processor can include a microprocessor, a microcontroller, a programmable integrated circuit, a programmable gate array, or another physical processing device.

The processor(s) 1102 can be coupled to a non-transitory machine-readable or computer-readable storage medium (or storage media) 1104. The storage medium (storage media) 1104 can store various machine-readable instructions, including weighted distance computation instructions 1106 (to compute weighted distances as discussed above), density-based grouping instructions 1108 (to perform density-based grouping as discussed above), and visualization instructions 1110 (to generate various visualizations). The weighted distance computation instructions 1106 computes weighted distances such as according to task 404 in FIG. 4 (using Eq. 1, for example). The density-based grouping instructions 1108 performs density-based grouping, such as according to task 406 in FIG. 4, to produce cohorts of data points such as shown in FIG. 3. The visualization instructions 1110 generate visualizations (e.g. visualizations of FIGS. 5-10), such as according to task 408 in FIG. 4.

The storage medium (or storage media) 1104 can include one or multiple different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A method comprising:
receiving, by a system including a processor, a user-selected group of data points;
computing, by the system, weighted distances between further data points and the user-selected group of data points, the weighted distances computed based on respective weights assigned to dimensions of the further data points and dimensions of the data points in the user-selected group of data points;
performing, by the system, density-based grouping of the further data points based on the computed weighted distances, the density-based grouping producing cohorts of data points; and
generating, by the system, a graphical visualization including pixels representing the user-selected group of data points and the cohorts of data points, the graphical visualization providing a temporal-based visualized identification of the cohorts of data points and the user-selected group of data points.

2. The method of claim 1, further comprising:
assigning different visual indicators to the respective cohorts of data points, wherein the pixels representing data points of a given cohort of the cohorts share a common visual indicator.

3. The method of claim 2, wherein assigning the different visual indicators to the respective cohorts of data points comprises assigning different colors to the respective cohorts of data points, and wherein the pixels representing data points of the given cohort share a common color.

4. The method of claim 1, wherein performing the density-based grouping comprises identifying a first cohort of data points that have weighted distances that differ by less than a specified threshold, the first cohort being one the cohorts.

5. The method of claim 4, wherein performing the density-based grouping comprises identifying a second cohort of data points that have weighted distances that differ by less than the specified threshold, the data points in the first cohort having weighted distances that differ by greater than the specified threshold from weighted distances of the data points in the second cohort, and the second cohort being one of the cohorts.

6. The method of claim 1, wherein computing the weighted distances between the further data points and the user-selected group of data points comprises performing binary comparisons between the further data points and the user-selected group of data points that are based on the respective weights assigned to the dimensions.

7. The method of claim 1, wherein receiving the user-selected group of data points comprise receiving the user-selected group of data points in a plot having a first axis corresponding to time and a second axis corresponding to multidimensional scaling (MDS) values.

8. The method of claim 7, further comprising:
assigning different visual indicators to the respective cohorts of data points presented in the graphical visualization, wherein the pixels representing data points of a given cohort of the cohorts share a common visual indicator; and
mapping the different visual indicators to corresponding data points represented in the plot.

9. A system comprising:
at least one processor to:
receive user-specified weights for dimensions of data points;
receive a user-selected group of data points;
compute weighted distances, based on the user-specified weights for the dimensions, between further data points and the user-selected group of data points;
sort, into a sorted list, the further data points according to the respective weighted distances of the further data points;
perform, using the sorted list, density-based grouping of the further data points to produce cohorts of data points; and
generate a graphical visualization including pixels representing data points in the cohorts, wherein the pixels in a given cohort of the cohorts share a common visual indicator, the graphical visualization providing a temporal-based visualized identification of the user-selected group of data points and the cohorts.

10. The system of claim 9, further comprising:
changing the user-specified weights or changing a user-selected group of data points; and
re-iterating the computing, the sorting, the performing, and the generating in response to the changing of the user-specified weights or the changing of a user-selected group of data points.

11. The system of claim 9, wherein the at least one processor is to present a control screen including control elements to perform at least one of the following: select a cohort of the cohorts to visualize, select a cohort of the cohorts to delete, and select cohorts to merge.

12. The system of claim 9, wherein the computing of the weighted distances comprises performing binary comparisons of the further data points to the user-selected group of data points along each respective dimension of the dimensions.

13. The system of claim 12, wherein a binary comparison of a given further data point to the user-selected group of data points along each respective dimension of the dimensions produces respective distance values for the respective dimension, and wherein the computing of the weighted distances further comprises aggregating the respective distance values for the respective dimension.

14. The system of claim 9, wherein the density-based grouping produces the cohorts based on comparisons of the weighted distances for the further data points to a specified threshold.

15. An article comprising at least one non-transitory machine-readable storage medium storing instructions that upon execution cause a system to:
receive a user-selected group of data points;
compute weighted distances between further data points and the user-selected group of data points, the weighted distances computed based on respective weights assigned to dimensions of the further data points and dimensions of the data points in the user-selected group;
perform density-based grouping of the further data points based on the computed weighted distances, the density-based grouping producing cohorts of data points;
generate, by the system, a graphical visualization including pixels representing the user-selected group of data points and the cohorts of data points, the graphical visualization providing a temporal-based visualized identification of the user-selected group of data points and the cohorts; and
assign a corresponding visual indicator to each respective pixel of the pixels based on which group or cohort from among the user-selected group and the cohorts a data point represented by the respective pixel is part of.
